(19) United States
(12) Patent Application Publication
(10) Pub. No.: US 2002/0077261 A1
(43) Pub. Date: Jun. 20, 2002

(54) Amino resin composition for mold cleaning

(75) Inventors: Kuen-Yuan Hwang, Hsinchu (TW); Hong-Hsing Chen, Hsinchu (TW); Chih-Fu Chen, Hsinchu (TW)

Correspondence Address: MR. PETER F. CORLESS, EDWARDS & ANGELL, LLP, 101 FEDERAL STREET, BOSTON, MA, 02110, US

(73) Assignee: Chang Chun Plastics Co., Ltd.

(21) Appl. No.: 09/982,493

(22) Filed: Oct. 18, 2001

(30) Foreign Application Priority Data
Oct. 18, 2000 (TW) TW89121774

(51) Int. Cl. C11D 1/00

(52) U.S. Cl. 510/175

(57) ABSTRACT

The present invention provides an amino resin composition for cleaning molds, that said composition is made of a thermosetting resin to which is a semi-cured amino resin composition or a semi-cured mixture thereof is added. The amino resin composition has decreased viscosity and increased tablet ability. When used to remove the soil on the surface of molds, the amino resin composition possesses good forming ability and good mold-cleaning effect so that the time needed for mold cleaning is efficiently decreased and the problem of a powder composition that can not be easily tabletted is overcome due to its excellent tablet ability.

### FIELD OF THE INVENTION

The present invention relates to amino resin compositions for mold cleaning, and more particularly, to an amino resin composition formed by adding a semi-cured amino resin or semi-cured mixture thereof to a thermosetting resin.

### BACKGROUND OF THE INVENTION

A thermosetting resin such as epoxy resin is normally used as a encapsulating material in a molding process for electronic circuits and semiconductor devices e.g. integrated circuit (IC), large scale integrated circuit (LSIC), transistor and diode. For continuously performing the molding process, a mold may be easily contaminated with the residual resin material. If such a mold is not cleaned prior to the next molding process, an encapsulant formed during molding can be contaminated with the residual resin material, or undesirably adhered to the mold to be hardly removed; this therefore significantly degrades quality of forming the encapsulant. Accordingly, it is important to clean the mold periodically in a manner that, after performing hundreds of times of the molding process, the mold needs to be cleaned by using a cleaning resin, so as to keep surfaces of the mold free of contaminant, and allow the molding process to be smoothly proceeded.

A conventional resin composition for mold cleaning is an amino resin composition, a type of thermosetting resin. Such a resin composition is made in tablets for use to clean a molding device adopted for fabricating semiconductor or IC elements. In practice use, the resin tablets are preheated to a temperature from 80° C. to 120° C., and then injected to fill the mold. After the resin is cured in the mold, contaminant can be removed together with the hardened resin from the mold, so that the mold cleaning purpose can be achieved.

In accordance for use with various molding devices, the tablets of the resin composition are dimensionally made in diameter within the range of from 10 to 70 mm. In production of the resin tablets by using a tablet-forming machine, it usually causes abrasion to th machine, and thus a super steel material is preferably used to overcome the abrasion problem. This therefore not only increases production costs, but also undesirable noise is generated due to surface friction between the tablets when the tablets are removed from the machine. Also, if the resin composition is not good to be made in tablets, the tablets are easily formed with cracks, thereby degrading the production yield of the tablets.

For example, Japanese Patent Publication Sho 64-10162 discloses a resin composition for mold cleaning which consists of a condensed resin of amino resin and phenol resin, and a mineral powder with hardness of 6 to 15 on the new Mohs' scale. Japanese Patent Publication Sho 52-788 discloses a method for cleaning a contaminated mold surface through the use of an amino-resin based material, and a resin for mold cleaning consisting of an amino-resin composition, an organic base or inorganic base, and a releasing agent. The Japanese Patent Publication Sho 52-788 is charactized in increasing an amount of the releasing agent used in the resin for mold cleaning, for allowing the resin to be more stably made in tablets and increasing yield thereof. However, in practical use, the releasing agent may leak out from the resin and thus cause contamination to the mold, thereby making the mold further contaminated but deteriorating the mold cleaning effect. Moreover, Taiwanese Patent No. 343171 discloses a small tablet of amino-resin composition; however, such tablets have a rapid setting rate, which limits the cleaning efficacy thereof. As a result, it needs to increase the cleaning frequency, so that costs and time for mold cleaning are both raised. Therefore, it is critically desired to find a resin composition that is easily made in tablets and good in cleaning ability.

The objective of the present invention is to provide an amino resin composition that the mold cleaning ability of the resin composition can be enhanced. Such a resin composition is made with increase in the apparent density, allowing its mold cleaning ability to be well assured even with addition of a releasing agent, as well as allowing the resin composition to be stably formed in tablets.

### DETAILED DESCRIPTION OF THE PREFERRED EMBODIMENTS

In order to accomplish the above and other objectives, the present invention proposes an amino resin composition for mold cleaning, which is formed by firstly adding a specifically-made semi-cured amino resin composition or a semi-cured mixture thereof to a general thermosetting resin, and then the mixture is pulverized, kneaded and homogeneously mixed with a xylene fiber material, inorganic filling material, releasing agent and promoter. The resulted amino resin composition can be made into tablets directly and stably no matter in the form of large tablets that are preheated for use, or in the form of small tablets that can used instantly without being preheated. Such an amino resin composition is also advantageous for its high production yield of tablets and excellent mold cleaning ability.

The amino resin used in the invention is a general amino resin such as malamine and the like.

The specifically-made semi-cured amino resin and a semi-cured mixture hereof used in the invention contains at least one methylol group, for example, malamine-aldehyde resin, malamine-phenol-formaldehyde resin, malamine-urea-formaldehyde resin, urea-formaldehyde, and the like. In a method for manufacturing the semi-cured amino resin, an amino compound such as urea and malamine, or a derivative thereof is heated and refluxed under stirring in the presence of a catalyst with formaldehyde or a derivative thereof, and optionally phenol or a derivative thereof, so as to form a semi-cured amino resin such as urea-formaldehyde resin, urea-phenol-formaldehyde resin, malamine-formaldehyde resin and malamine-phenol-formaldehyde resin. In the foregoing reaction, the molar ratio of formaldehyde or a derivative thereof (hereinafter designated as F) to the amino compound (hereinafter designated as M), i.e. F/M, is necessarily greater than 1.0, so as to initiate a cross-linking setting reaction in the condition of formaldehyde (F) acting as a cross-linking agent to be greater in amount than urea or malamine (M) in the resin. The ratio F/M can be within the range of from 1.0 to 6.0, preferably from 1.0 to 2.5. With the addition of phenol or a derivative thereof (hereinafter designated as P), the molar ratio ((P+F)/(M)) of a sum (P+F) of phenol or a derivative thereof and formaldehyde or a derivative thereof to the amino resin (M) is within the range of from 1.0 to 6.0, preferably from 1.0 to 2.5.

The catalyst used herein can be a basic material such as oxide or hydroxide of Group I or Group II alkali or alkali metal, amine aqueous solution, other amines, and the like. The catalyst can be used alone or as a combination of two or more thereof. The usage amount of the catalyst is preferably ≦5%, based on the total weight of reactants.

The temperature of the reaction can be in the range of from 50° C. to 100° C. The reaction is to obtain a semi-cured amino resin; therefore when gel time of the reactants reaches a predetermined time, the reactants are dried under reduced pressure to stop the reaction, wherein dryness is adjusted in extent to control water content according to desired solid content. Preferably, the solid content is 75% or more, and more preferably 85% or more. This results in a semi-cured amino resin having at least one methylol group, with solid content of 75% or more. The gel time is measured as the time for stirring a resin on a hot plate without forming filamets, according to the JIS K6909 method.

As compared to a conventional dry method, the reaction process of the invention requires neither expensive solid amino resin nor an additional organic solvent that is used in a wet method. Thus, a procedure for drying to remove the solvent is omitted, and contamination caused by the volatilization of the organic solvent can be avoided, as well as costs can be reduced.

The amino resin composition for mold cleaning of the invention therefore includes the foregoing obtained semi-cured amino resin having at least one methylol group, together with other thermosetting resin and additives, are stirred and mixed homogeneously in a semi-cured manner in a device such as a kneading machine, ball mill, tumble, rapid mixer and the like. Then, the mixture is charged into a roller, or a single or double-shaft presser for compounding. After the semi-cured amino resin cross-links, it is cooled and pulverized into particles or powders by using a pulverizer, so as to obtain the amino resin composition for mold cleaning of the invention.

The additives mentioned above can be, for example, pulp, wood powder fiber material, inorganic filling material, releasing agent, hardening promoter, and the like.

A method for making the amino resin composition for mold cleaning of the invention is to heat and compound the semi-cured amino resin or a semi-cured mixture thereof having at least one methylol group with solid content of more than 75% alone, or to heat and compound it with other thermosetting resins together, and then under a semi-cured condition, other additives are added to allow the semi-cured amino resin to polymerize into an amino resin material having a higher molecular weight. Such a material with higher molecular weight is the amino resin composition used for mold cleaning as proposed by the invention. Since the method of the invention has the advantages but not the disadvantages of conventional dry or wet methods, wherein the drying procedure in the wet method can be omitted, and the volatilization of a large amount of toxic odorous solvents can be avoided. Moreover, the invention does not use expensive raw materials as in the dry method, and thus the cleaning problems caused by transporting powders of the raw materials can be avoided. Therefore, since the method of the invention is simple in process without the use of organic solvents, thus it is beneficial both economically and environmentally.

The general thermosetting resin used in the invention is normally added in an amount of about 30 to 60 wt %, preferably about 40 to 50 wt %, of the total weight of the amino resin composition.

The added amount of the semi-cured amino resin or a semi-cured mixture thereof used in the invention is in the range of about 40 to 70 wt %, preferably about 50 to 60 wt %, of the total weight of the amino resin composition.

The paper or wood powder fiber material used in the invention preferably has 80 wt % or more, more preferably 95 wt % or more, of particles passing through No. 80 screen. The added paper or wood powder fiber material is in the range of 10 to 80 wt % of the total weight of the amino resin composition.

The inorganic filling material used in the invention includes compounds of metal, such as silicon, iron, titanium, sodium, calcium, chromium, manganese, boron, aluminum, or the like; for example, oxides or hydroxides (such as magnesium oxide, calcium oxide, zinc oxide, manganese oxide, aluminum oxide, silicon oxide, silicon dioxide, aluminum hydroxide, magnesium hydroxide, or the like), sulfates and sulfides of metal (such as calcium sulfate, barium sulfate, zinc sulfide, or the like), metal silicates (such as magnesium silicate, calcium silicate, or the like), carbides (such as silicon carbide, and the like), mineral powders (such as carborumdum, corundum powder, talc powder, diatomaceous earth, kaolin, talc powder, silica, sakura stone, or the like), or glass fibers (the ratio L/D of glass fiber length L to glass fiber diameter D is 5000 or less). The added inorganic filling material is in the range of 0.01 to 80 wt %, more preferably 10 to 48 wt %, of the total weight of the amino resin composition.

The mineral powder suitably used in the inorganic material mentioned above can include, for example, natural mineral such as carbordum, corundum powder, talc powder, diatomaceous earth, kaolin, talc powder, silica, sakura stone or the like, and oxide or carbide of silicon, iron, titanium, sodium, calcium, chromium, manganese, boron, aluminum or the like. The average particle size of the powder is preferably under 150 μm, more preferably under 100 μm, and most preferably under 40 μm.

The releasing agent useful in the invention includes aliphatic releasing agent (such as stearic acid, zinc stearate, magnesium stearate, calcium stearate, butyl stearate), aliphatic amido releasing agent (for example saturated or unsaturated monoamide type of releasing agents such as dodecyl amide, tetradecyl amide, oleamide, stearamide, or the like, and saturated or unsaturated diamide type of releasing agents such as dioleamide, distearamide, or the like), alcoholic releasing agent (such as polyethylene glycgl 400 (PEG400), PEG1000, high alcohol), paraffinic releasing a (which is mainly linear carbohydrate having 28 to 90 carbons, for example, liquid paraffin, paraffin, paraffin wax, Sasol Wax, or the like), and silicic releasing agent (such as silicon oil). The added amount of the releasing agent is from 0.01 wt %, to 10 wt %, preferably from 1.5 to 5.0 wt %, based on the total weight of the amino resin composition. In the case of fatty acid metallic salt (such as zinc stearate, magnesium stearate, and calcium stearate), the added amount thereof can be from 0.5 wt % to 10 wt %, whereas in the case of fatty acid (such as stearic acid, and butyl stearate), the added amount thereof can be in the range of 0.01 wt % to 0.1 wt %, so as to improve the quality and yield of tablets, and to assure stability and mold cleaning effect of the amino resin composition. If the added amount of the above releasing agent is not sufficient, the amino resin composition is not capable of entirely filling a mold, thereby resulting in poor cleaning effect. Also, the hardened amino resin composition can be adhered to the mold surface due to poor in releasing ability, this further deteriorates the mold cleaning efficacy.

The hardening promoter useful in the present invention includes inorganic acidic hardening promoter (such as sulfuric acid, boric acid, phosphorous acid, hydrochloric acid, and the like), organic acidic hardening promoter (such as oxalic acid, benzoic acid, phthalic anhydride, p-toluene sulfonic acid, and the like), organic ammonium salt hardening promoter (the salts formed from the above acids and tiethanolamine, triethylamine, 2-methyl-2-amino-1-propanol, or the like, are for example, CATANITTO, CATANITTO-A, or the like), and inorganic metal salt hardening promoter (such as zinc sulfite or the like). The added amount of the hardening promoter is from 0.01 to 10 wt %, based on the weight of the amino resin composition.

The amino resin composition for cleaning molds of the present invention can be made into tablets, platelets, or powder, and is effective in mold cleaning.

The examples and comparative examples are exemplified as follows and describe in more detail the present invention, but they should not be construed to limit the scope of the present invention.

Gel Time measured in the above specification and examples is the time when the resin stirred on a hot plate (measured under 150° C.) does not form filaments, according to the method of JIS K6909.

The rate of curing the amino resin composition of the present composition (T90 value) is in the range of from 450 seconds to 750 seconds and is measured as follows:

The method of the measurement for the rate of setting (T90 value):

The commercial JSR type of setting meter is used. When the temperature of the surface of a mold is kept at 145° C., the mold is subjected a vibration with a certain amplitude and deforms. The change of the stress of the amino resin composition for cleaning molds is monitored according to the elapsed time for setting. The time required is T90 value (seconds) when the change of the stress reaches 90% of the maximum value.

The present invention is illustrated by the following example.

### EXAMPLE 1

310 weight part of malamine, 130 weight part of phenol, 540 weight part of 37% formaldehyde aqueous solution, and 5 weight part of calcium hydroxide were added into a flask. After the mixture was heated and refluxed under 80° C. for 30 minutes, it was cooled to 45° C., followed by heating and refluxing under 85° C. for 60 minutes. Then, the reaction mixture was neutralized with 10% sodium hydroxide solution and dried under vacuum, so as to obtain a semi-cured amino resin of malamine-phenol-formaldehyde having 85% of solid content and gelation time of 4 minute and 30 second (measured under 150° C.).

20 wt % of the semi-cured amino resin, 50 wt % of malamine resin, 20 wt % of silica powder with mean particle size under 20 μm, 1.82 wt % zinc stearate, 0.08 wt % of PEG400, 8 wt % of paper pulp, and 0.1 wt % of benzoic acid, based on 100 wt % total weight of resin composition, were homogeneously pulverized and mixed by a ball mill. Alternatively, other means could be used to pulverize and sufficiently homogenize and mix the components. A resin composition for cleaning molds was obtained.

### EXAMPLE 2

25 wt % of the semi-cured type of malamine-phenol-formaldehyde amino resin as in example 1 and 10 wt % of paper pulp, based on 100 wt % total weight of resin composition, were mixed and kneaded to give the semi-solidifying mixture. Then 45.7 wt % of malamine resin, 17 wt % of silica powder with mean particle size less than 20 μm, 1.8 wt % zinc stearate, 0.2 wt % of benzoic acid, and 0.2 wt % of CATINITTO were added to the mixture, to be then homogeneously pulverized, and mixed by a ball mill. Thereafter, 0.1 wt % of PEG400 was further added and subjected to a last stage of mixing. A resin composition for cleaning molds was obtained.

### EXAMPLE 3

340 weight part of malamine, 100 weight part of urea, and 550 weight part of 37% formaldehyde aqueous solution were poured into a flask. After the mixture was heated and refluxed at a temperature of 70° C. for 50 minutes, it was allowed to cool to 50° C., after which, it was heated and refluxed again at a temperature of 100° C. for 100 minutes, then dried under a vacuum. A semi-cured type of amino resin of malamine-phenol-formaldehyde having 85% of solid content and a gelation time of 5 to 6 minutes (measured under 150° C.) was obtained.

30 wt % of the semi-cured substance, 48 wt % of malamine resin, 20 wt % of silica powder with mean particle size less 20 μm, 1.8 wt % zinc stearate, 0.08 wt % of PEG400, 8 wt % of paper pulp, and 0.12 wt % of benzoic acid, based on 100 wt % total weight of resin composition, were homogeneously pulverized, kneaded and mixed by a ball mill. Alternatively, other means could be used to homogeneously pulverize and sufficiently mix the components. A resin composition for cleaning molds was obtained.

### EXAMPLE 4

The same procedures as carrier out in example 1 were repeated, except that 0.1 wt % of benzoic acid in example 1 was deceased to 0.01 wt %. A resin composition for cleaning molds was obtained.

### EXAMPLE 5

The same procedures as carrier out in example 1 were repeated, except that 20 wt %, of the semi-cured substance in example 1 was changed to 30 wt % and 50 wt % of malamine resin was changed to 40 wt %. A resin composition for cleaning molds was obtained.

### COMPARATIVE EXAMPLE 1

The same procedures as carrier out in example 1 were repeated, but releasing agent, zinc stearate and PEG400, were not added and the amount of silica powder was changed to 21.8 wt %. A resin composition for cleaning molds was obtained.

### COMPARATIVE EXAMPLE 2

While the same procedures as carrier out in example 1 were repeated, without the addition of releasing agent, zinc stearate, were not added. A resin composition for cleaning molds was obtained.

### COMPARATIVE EXAMPLE 3

While the same procedures as carrier out in example 1 were repeated, releasing agent and, PEG400, were not added and the amount of silica powder was changed to 20.08 wt %. A resin composition for cleaning molds was obtained.

### COMPARATIVE EXAMPLE 4

While the same procedures as carrier out in example 1 were repeated, the amount of releasing agent, zinc stearate, as increased to 11.72 wt %. As well, the amount of silica powder was changed to 15 wt %, and the amount of malamine resin, was changed to 15 wt %. A resin composition for cleaning molds was obtained.

### COMPARATIVE EXAMPLE 5

While the same procedures as carrier out in example 1 were repeated, the amount of releasing agent, zinc stearate was changed to 0.72 wt % and the amount of silica powder was changed to 21 wt %. A resin composition for cleaning molds was obtained.

### COMPARATIVE EXAMPLE 6

The same procedures as carrier out in example 2 were repeated, but 20 wt % of semi-cured type of amino resin was decreased to 10 wt % and 49 wt % of malamine resin was increased to 59 wt %. A resin composition for cleaning molds was obtained.

### COMPARATIVE EXAMPLE 7

While the same procedures as carrier out in example 1 were repeated, the amount of zinc stearate was changed to 1.2 wt % and the amount of PEG400 was changed to 0.6 wt %. A resin composition for cleaning molds was obtained.

The resin compositions or cleaning molds of the above examples and comparative examples were tested as follows for the comparison of the advantages and disadvantages of their mold cleaning ability and their ability to form tablets.

Test Method 1 Soil removing on the surface of molds

The surface of molds will be contaminated after moldings in the molding process have been processed more than 1000 times in the mold of the out automated molding machine where commercial epoxy resin molding tablets, for example SUMIKON 7320CR have been used. Therefore it is necessary to use the resin composition to clean the mold. The number of cleanings is recorded and the cleaning effect is evaluated according to the following criteria. In this test method, the temperature of the mold for molding is 180° C., and the time for setting is 180 seconds. The criteria for evaluation is as follows:

5: completely no soil residue

4: almost no soil residue

3: little soil residue

2: having soil residue

1: much soil residue

### TEST EXAMPLE 1

The soil test for the surface of molds were processed by the procedures as set forth in test method 1, using the resin composition for cleaning molds obtained according to the methods in the examples and the comparative examples, and the effect of cleaning was evaluated according to the standards for evaluation in test method 1. The result is shown in table 1. In light of table 1, it is demonstrated that the resin composition of the present invention has very excellent effect for mold cleaning, which allows it to completely remove the soil on the surface of the mold after 2 to 3 injections when it reaches the evaluation criterion ‘5’, superior to the comparative examples which need 8 to 9 injections to obtain the same effect.

TABLE 1
Soil Removing Test on the Surface of Molds

| | Mold Cleaning Ability of the Resin | | | | | | | | | |
|---|---|---|---|---|---|---|---|---|---|---|
| | Composition Number of Mold Cleaning | | | | | | | | | |
| Resin Composition | 1 | 2 | 3 | 4 | 5 | 6 | 7 | 8 | 9 | 10 |
| Example 1 | 3 | 5 | — | — | — | — | — | — | — | — |
| Example 2 | 3 | 5 | 5 | — | — | — | — | — | — | — |
| Example 3 | 3 | 4 | 5 | — | — | — | — | — | — | — |
| Example 4 | 3 | 4 | 5 | — | — | — | — | — | — | — |
| Example 5 | 3 | 4 | 5 | — | — | — | — | — | — | — |
| Comparative | 3 | 2 | 2 | 3 | 3 | 4 | 4 | 4 | 5 | — |
| Example 1 | | | | | | | | | | |
| Comparative | 1 | 1 | 2 | 2 | 2 | 3 | 4 | 4 | 5 | — |
| Example 2 | | | | | | | | | | |
| Comparative | 1 | 2 | 3 | 3 | 3 | 4 | 4 | 4 | 5 | — |
| Example 3 | | | | | | | | | | |
| Comparative | 1 | 2 | 2 | 3 | 3 | 4 | 4 | 5 | — | — |
| Example 4 | | | | | | | | | | |
| Comparative | 2 | 2 | 2 | 3 | 3 | 4 | 4 | 5 | — | — |
| Example 5 | | | | | | | | | | |
| Comparative | 2 | 2 | 2 | 3 | 3 | 4 | 4 | 4 | 5 | — |
| Example 6 | | | | | | | | | | |
| Comparative | 2 | 2 | 2 | 3 | 3 | 4 | 4 | 4 | 5 | — |
| Example 7 | | | | | | | | | | |

*: The evaluation method is the same as in test method 1.

Test Method 2 The effect of mold cleaning for different molding temperatures and times of setting

The surface of molds will be contaminated when sealed moldings has been proceed for more than 1000 times in the mold of the automated molding machine using commercial epoxy resin molding material tablets, for example, SUMIKON 5050S; therefore it is necessary to use the resin composition for cleaning molds to clean the mold. In this test method, each resin composition for cleaning the mold is used to clean the mold at tempeatures of 150° C., 160° C., 170° C., 180° C., and 190° C., for 180 seconds, 240 seconds, and 300 seconds, respectively. The effect of cleaning is evaluated according to the criteria for evaluation as in test method 1.

### TEST EXAMPLE 2

Each of the resin compositions of the present invention and the comparative examples was used to clean the mold at various temperatures for a period of three setting times: 180 seconds, 240 seconds and 300 seconds. The effect of cleaning was evaluated according to the criteria for evaluation as in test method 1. The result is shown in Table 2. As shown in Table 2, it is demonstrated that the resin composition of the present invention has very excellent effects for mold cleaning. Even when the composition of the present invention sets for 180 seconds or 240 seconds under the lower molding temperature of 150° C. or 160° C., the complete effect of soil removal could be obtained; for conditions of higher temperatures and longer setting time the procedure was even more effective. For the comparative examples, the complete effect of soil removing could not be obtained even under a higher molding temperature of 170 or 180° C., and longer setting time such as 300 seconds; the same effect could be only obtained under higher molding temperature of 190° C., and a longer setting time of 300 seconds. In view of the above, it is demonstrated that the effect of mold cleaning for the composition of the present invention is superior to the comparative examples.

TABLE 2
Soil Removing Test for different mold temperatures and setting times

| Example No | | | | | | |
|---|---|---|---|---|---|---|
| Resin | | Cleaning Efficacy of the Resin Composition | | | | |
| Composition | | 150° C. | 160° C. | 170° C. | 180° C. | 190° C. |
| Example 1 | 180 Sec. | 4 | 4 | 5 | 5 | 5 |
| | 240 See. | 4 | 5 | 5 | 5 | 5 |
| | 300 Sec. | 5 | 5 | 5 | 5 | 5 |
| Example 2 | 180 Sec. | 4 | 4 | 5 | 5 | 5 |
| | 240 Sec. | 4 | 5 | 5 | 5 | 5 |
| | 300 See. | 5 | 5 | 5 | 5 | 5 |
| Example 3 | 180 Sec. | 4 | 4 | 5 | 5 | 5 |
| | 240 Sec. | 4 | 5 | 5 | 5 | 5 |
| | 300 Sec. | 5 | 5 | 5 | 5 | 5 |
| Example 4 | 180 Sec. | 4 | 4 | 5 | 5 | 5 |
| | 240 Sec. | 4 | 5 | 5 | 5 | 5 |
| | 300 Sec. | 5 | 5 | 5 | 5 | 5 |
| Example 5 | 180 Sec. | 4 | 4 | 5 | 5 | 5 |
| | 240 Sec. | 4 | 5 | 5 | 5 | 5 |
| | 300 Sec. | 5 | 5 | 5 | 5 | 5 |
| Comparative | 180 Sec. | 2 | 2 | 2 | 2 | 3 |
| Example 1 | 240 Sec. | 2 | 2 | 2 | 3 | 4 |
| | 300 Sec. | 3 | 3 | 4 | 4 | 5 |
| Comparative | 180 Sec. | 2 | 2 | 2 | 2 | 3 |
| Example 2 | 240 Sec. | 2 | 2 | 3 | 3 | 3 |
| | 300 Sec. | 3 | 3 | 4 | 4 | 4 |
| Comparative | 180 Sec. | 2 | 2 | 2 | 2 | 3 |
| Example 3 | 240 Sec. | 2 | 2 | 3 | 3 | 4 |
| | 300 Sec. | 3 | 3 | 4 | 4 | 4 |
| Comparative | 180 Sec. | 2 | 2 | 2 | 2 | 3 |
| Example 4 | 240 Sec. | 2 | 2 | 3 | 3 | 4 |
| | 300 Sec. | 3 | 3 | 3 | 4 | 5 |
| Comparative | 180 Sec. | 2 | 2 | 2 | 2 | 3 |
| Example 5 | 240 Sec. | 2 | 2 | 3 | 4 | 4 |
| | 300 Sec. | 3 | 3 | 4 | 4 | 5 |
| Comparative | 180 Sec. | 2 | 2 | 2 | 2 | 3 |
| Example 6 | 240 Sec. | 2 | 2 | 3 | 3 | 4 |
| | 300 Sec. | 2 | 3 | 4 | 4 | 5 |
| Comparative | 180 Sec. | 2 | 2 | 2 | 3 | 3 |
| Example 7 | 240 Sec. | 2 | 2 | 3 | 4 | 4 |
| | 300 Sec. | 3 | 3 | 4 | 4 | 5 |

The tablet efficacy of resin composition for cleaning molds of the present invention was evaluated according to the following method.

Test Method 3 The method of measurement for tablet ability

4.5 Grams of resin composition for molding was filled into a mold (180 mm φ×30 mm H), pressurized to 350 Kg/cm², and kept 5 to 20 seconds. Thereafter, the upper mold was removed and the pressure was increased to release the tablet. The time required for producing 100 tablets was calculated to obtain the production rate. The appearance of the tablets made from the process were inspected for any cut or damages in order to calculate the percentage of failure from the number of defective-tablets to evaluate the tablet efficacy of said resin composition.

Also, the resulting tablets were weighed respectively to obtain the distribution of weight to further evaluate the tablet ability of said resin composition. The criteria of evaluation were as follows:

\mathring{∘}: weight error ±0.1 g

◯: weight error ±0.5 g

x: weight error ±1.0 g

Test Method 3

The tablet ability of the resin composition for cleaning molds obtained according to the method in the examples and the comparative examples mentioned above was evaluated according to test method 3. The result was shown in table 3. As shown in table 3, it is demonstrated that the resin composition for cleaning molds of the present invention has very excellent tablet ability. The production rate of tablets for the composition of the present invention was 420 to 480 tablets per minute. The percentage of failure was extremely low, only 0 to 1%. The distribution of weight was very sharp and the deviation was less than 0.1 gram. For the comparative examples, the production rate of tablet was only 60 to 180 tablets per minute, the percentage of failure was up to 12 to 18%, the distribution of weight was wide and the deviation was more than 0.5 gram, even more than 1.0 gram. From this result, it can be affirmed that the tablet ability of the composition of the present invention is superior to the comparative examples.

TABLE 3
The tablet ability of the amino resin composition of the present invention

| | Tablet Efficacy of Resin Composition | | |
|---|---|---|---|
| Example No | Production Rate | Mal Ratio | Weight |
| Resin Composition | (No. of tablets/min) | % | Distribution |
| Example 1 | 480 | 0 | ⊚ |
| Example 2 | 480 | 0 | ⊚ |
| Example 3 | 420 | 1 | ⊚ |
| Example 4 | 480 | 1 | ⊚ |
| Example 5 | 420 | 0 | ⊚ |
| Comparative Example 1 | 180 | 12 | ∘ |
| Comparative Example 2 | 180 | 13 | ∘ |
| Comparative Example 3 | 60 | 17 | x |
| Comparative Example 4 | 120 | 16 | x |
| Comparative Example 5 | 60 | 18 | x |
| Comparative Example 6 | 120 | 15 | x |
| Comparative Example 7 | 120 | 14 | ∘ |

* percentage of failure = (the number of damaged tablets produced per minute the number of tablets produced per minute) × 100%

What is claimed is:

1. An amino resin composition for cleaning molds, composing 30 to 60 wt. % of thermosetting resin and 40 to 70 wt. % of at least one methylol-containing amino resin which has at least 75 wt. % of solid content.

2. The amino resin composition for cleaning molds according to claim 1, wherein said amino resin is selected from the group consisting of urea, amino compounds of malamine, formaldehyde and the derivatives thereof.

3. The amino resin composition for cleaning molds according to claim 1, further comprising xylon material, inorganic filling material, a releasing agent, and a hardening promoter.

4. The amino resin composition for cleaning molds according to claim 3, wherein said inorganic filling material is selected from the group consisting of metal oxides, metal hydroxides, metal carbonates, metal sulfates, metal sulfides, metal silicates, metal silicates, metal powders, and glass fibers and the added amount is from 0.01 to 80 wt. %, based on the weight of the amino resin composition.

5. The amino resin composition for cleaning molds according to claim 3, wherein said inorganic filling material is mineral powder which has a mean particle size less than 150 μm.

6. The amino resin composition for cleaning molds according to claim 3, wherein said releasing agent is selected from the group consisting of aliphatic releasing agent, aliphatic amido releasing agent, alcoholic releasing agent, paraffinic releasing agent and silicic releasing agent and the added amount is from 0.01 wt. % to 10 wt. %, based on the total weight of the amino resin composition.

7. The amino resin composition for cleaning molds according to claim 6, wherein the added amount of said releasing agent is preferably from 0.5 wt. % to 5.0 wt. %, based on the total weight of the amino resin composition.

8. The amino resin composition for cleaning molds according to claim 3, wherein said hardening promoter is selected form the group consisting of inorganic acidic hardening promoter, organic acidic hardening promoter, organic ammonium salt hardening promoter and inorganic metal salt hardening promoter and the added amount is from 0.01 to 10 wt. %, based on the weight of the amino resin composition.

9. The amino resin composition for cleaning molds according to claim 3, wherein said xylon fiber material contain at least 80 wt. % of particles which can pass through sieve No. 80 and the added amount is within the range of from 10 wt. % to 80 wt. %, based on the total weight of the amino resin composition.

10. The amino resin composition for cleaning molds according to claims 1, wherein curing time of the amino resin composition for cleaning molds is in the range of 450 to 750 seconds, measured by using JSR type of curing meter.

11. The amino resin composition for cleaning molds according to claim 1 and 2, which is made into a tablet from.

12. The amino resin composition for cleaning molds according to claim 1 and 2, which is made into a sheet from.

13. The amino resin composition for cleaning molds acording to claim 1, which is made into a powder from.

14. An amino resin composition for cleaning molds, said composition includes from 30 to 60 wt. % of thermosetting resin and 40 to 70 wt. % of a semi-cured additive of at least one methylol-containing amino resin which has at least 75 wt. % of solid content.

15. The amino resin composition for cleaning molds according to claim 14, wherein said amino resin is selected from the group consisting of urea, amino compounds of malamine, formaldehyde and the derivatives thereof.

16. The amino resin composition for cleaning molds according to claim 14, further comprising xylon material, inorganic filling material, a releasing agent, and a hardening promoter.

17. The amino resin composition for cleaning molds according to claim 16, wherein said inorganic filling material is selected from the group consisting of metal oxides, metal hydroxides, metal carbonates, metal sulfates, metal sulfides, metal silicates, metal silicides, mineral powders, and glass fibers and the added amount is from 0.01 to 80 wt. %, based on the weight of the amino resin composition.

18. The amino resin composition for cleaning molds according to claim 16, wherein said inorganic filling material is mineral powder which has a mean particle size less than 150 μm.

19. The amino resin composition for cleaning molds according to claim 16, wherein said releasing agent is selected from the group consisting of aliphatic releasing agent, aliphatic amido releasing agent, alcoholic releasing agent, paraffinic releasing agent and silicic releasing agent and the added amount is from 0.01 wt., % to 10 wt. %, based on the total weight of the amino resin composition.

20. The amino resin composition for cleaning molds according to claim 19, wherein the added amount of said releasing agent is preferably from 0.5 wt. % to 5.0 wt. %, based on the total weight of the amino resin composition.

21. The amino resin composition for clay molds according to claim 16, wherein said hardening promoter is selected form the group consisting of inorganic acidic hardening promoter, organic acidic hardening promoter, organic ammonium salt hardening promoter and inorganic metal salt hardening promoter and the added amount is from 0.01 to 10 wt. %, based on the weight of the amino resin composition.

22. The amino resin composition for cleaning molds according to claim 16, wherein said xylon fiber material contains at least 80 wt. % of particles which can pass through sieve No. 80 and the added amount is within the range of from 10 wt. % to 80 wt. %, based on the total weight of the amino resin composition.

23. The amino resin composition for cleaning molds according to claims 14, wherein curing time of the amino resin composition for cleaning molds is in the range of 450 to 750 seconds, measured by using JSR type of curing meter.

24. The amino resin composition for cleaning molds according to claim 14, which is made into a tablet from.

25. The amino resin composition for cleaning molds according to claim 14, which is made into a sheet from.

26. The amino resin composition for cleaning molds according to claim 1 and 2, which is made it a powder from.
